(19) United States
(12) Patent Application Publication
(10) Pub. No.: US 2004/0251132 A1
(43) Pub. Date: Dec. 16, 2004

(54) Reduced volume strip

(76) Inventors: Christopher Philip Leach, Inverness (GB); Erica Mary Beck, Naim (GB)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/860,180

(22) Filed: Jun. 2, 2004

Related U.S. Application Data
(60) Provisional application No. 60/476,730, filed on Jun. 6, 2003.

(51) Int. Cl. G01N 27/403

(52) U.S. Cl. 204/403.01

(57) ABSTRACT

A sensor for performing an electrochemical test for an analyte in a sample comprising a substrate, a conductive layer disposed on said substrate, one conductive layer comprising a reference electrode and at least one working electrode; an insulation layer disposed on at least a part of said conductive layer so as to expose a portion of said conductive layer; a reagent layer covering at least a part of said exposed portion of said conductive layer; and an adhesive layer defining at least part of a wall of a sample receiving chamber and wherein said adhesive layer covers at least a portion of said reagent layer.

### CROSS-REFERENCE

This application claims the benefit of U.S. Provisional Application No. 60/476,730, filed Jun. 6, 2003, which application is incorporated herein by reference.

### BACKGROUND OF THE INVENTION

### FIELD OF THE INVENTION

The present invention relates, in general, to electrochemical strips for the detection of glucose and, more particularly, to electrochemical strips for the detection of glucose wherein the walls of the adhesive layer touch or overlap with the reagent layer.

The detection of the concentration of glucose in blood may be accomplished using electrochemical meters and associated test strips such as the Ultra meter and Ultra test strip, which are available from LifeScan, Inc. When utilizing such electrochemical meters and test strips, a patient would normally lance the skin to draw blood into the strip. The amount of blood required is a function of a number of factors, including the shape and size of the sample cell on the strip. The amount of blood required to fill the sample chamber is important because the user may perceive that large blood samples will require larger lancing wounds and, thus, more pain. It would, therefore, be advantageous to design test strips with small sample chambers.

### SUMMARY OF THE INVENTION

In one embodiment of the present invention, a sensor may include a substrate, a conductive layer disposed on the substrate, an insulation layer disposed on a part of the conductive layer to expose a portion of the conductive layer, a reagent layer covering at least a portion of the exposed conductive layer, an adhesive layer touching (for example, overlapping or lying adjacent) to the reagent layer, and a top layer disposed on top of the adhesive to form a sample receiving chamber. In an embodiment of the present invention, the adhesive layer height is between about 10 to 150 microns, and more preferably between 70 and 110 microns, and yet more preferably between 70 and 90 microns, in order to reduce the volume of the sensor. In order to reduce the volume of a sensor, the width of the sample receiving chamber was reduced such that the walls of the adhesive layer touch or overlap with the reagent layer. The sample receiving chamber further includes a sample chamber width which is defined by the walls of the adhesive layer. By decreasing the size of the sample chamber width, this caused a reduction in sample volume and also caused the reagent layer to touch or overlap with the adhesive layer.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a perspective view of an unassembled test strip embodiment of the prior art invention.

FIG. 1B is a perspective view of an unassembled test strip embodiment of the present invention.

FIG. 2 is a perspective view of an assembled test strip of either the prior art invention or the present invention.

FIG. 3 is a simplified plane view of a distal portion of a test strip according to either the prior art invention or the present invention which includes a conductive layer and an insulation layer.

FIG. 4A is a simplified perspective view of a distal portion of a test strip according to the prior art invention

FIG. 4B is a cross-sectional view of the test strip illustrated in FIG. 4A.

FIG. 4C is a simplified plane view of a distal portion of the test strip illustrated in FIG. 4A including a conductive layer, an insulation layer, a reagent layer, and an adhesive layer.

FIG. 5A is a simplified perspective view of a distal portion of a test strip according to the present invention

FIG. 5B is a simplified perspective view of a distal portion of a test strip according to the present invention.

FIG. 5C is a simplified plane view of a distal portion of the test strip illustrated in FIG. 5A including a conductive layer, an insulation layer, a reagent layer, and an adhesive layer.

FIG. 6 is a cross-sectional view of a step in a method of manufacturing the test strip in accordance with the present invention wherein a screen mesh with an emulsion pattern printing adhesive is positioned over a partially formed test strip.

FIG. 7 is a graph of glucose response stability data for aged batch 1 and 2 strips at 50° C. and 50 mg/dL glucose concentration in accordance with the present invention.

FIG. 8 is a graph of glucose response stability data for aged batch 1 and 2 strips at 50° C. and 100 mg/dL glucose concentration in accordance with the present invention.

FIG. 9 is a graph of glucose response stability data for aged batch 1 and 2 strips at 50° C. and 500 mg/dL glucose concentration in accordance with the present invention.

### DETAILED DESCRIPTION OF ILLUSTRATIVE EMBODIMENTS OF THE INVENTION

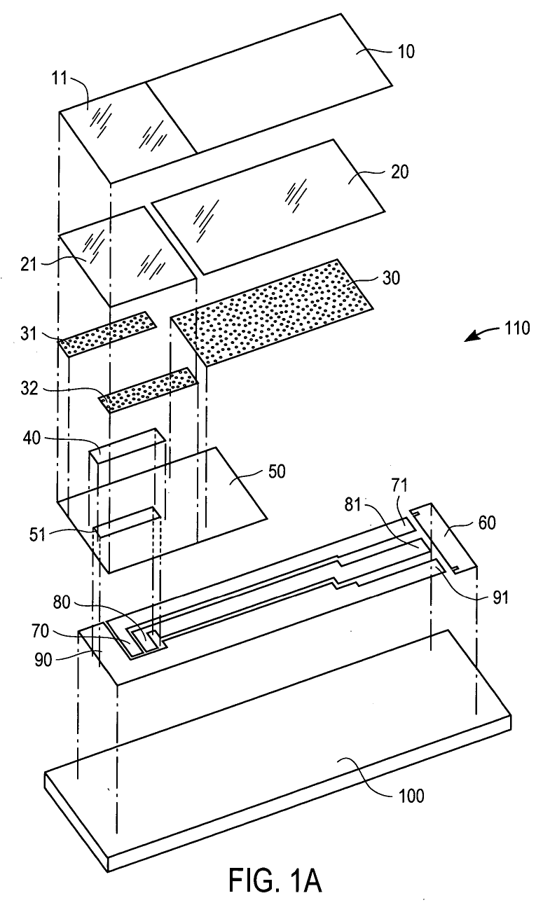

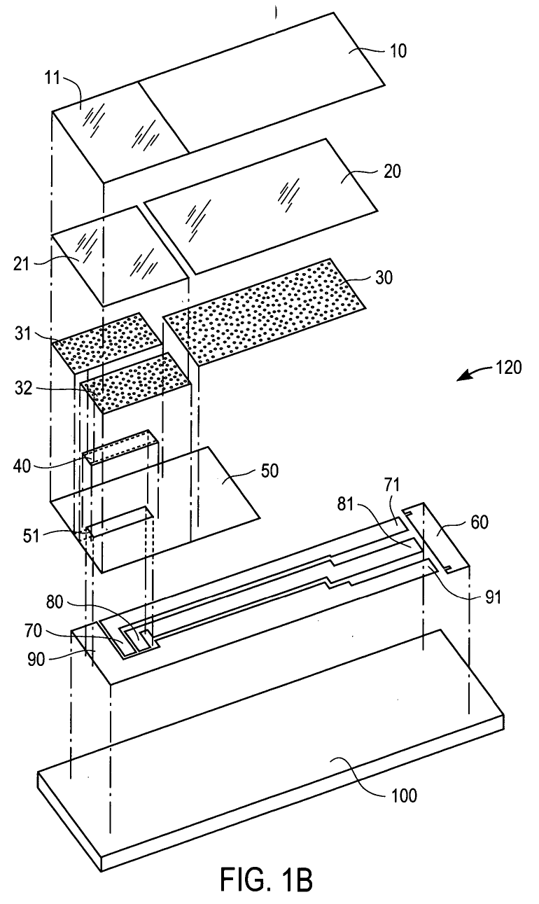

FIG. 1A is a perspective view of an unassembled test strip 110 embodiment of the prior art invention. Test strip 110 in FIG. 1A includes a substrate 100, a first working electrode 70, a second working electrode 80, a reference electrode 90, a first contact 71, a second contact 81, a reference contact 91, a strip detection bar 60, an insulation layer 50 which has a cutout 51, an reagent layer 40, a first adhesive pad 30, a second adhesive pad 31, a third adhesive pad 32, a first hydrophilic film 20, a second hydrophilic film 21, and a top film 11 which has an opaque portion 10.

FIG. 1B is a perspective view of an unassembled reduced volume test strip 120 embodiment of the present invention. In contrast to FIG. 1A, reduced volume test strip 120 has a wider second and third adhesive pads (31 and 32) which causes second and third adhesive pads (31 and 32) to overlap with reagent layer 40. Reduced volume test strip 120 in FIG. 1B also includes a substrate 100, a first working electrode 70, a second working electrode 80, a reference electrode 90, a first contact 71, a second contact 81, a reference contact 91, a strip detection bar 60, an insulation layer 50 which has a cutout 51, an reagent layer 40, a first adhesive pad 30, a second adhesive pad 31, a third adhesive pad 32, a first hydrophilic film 20, a second hydrophilic film 21, and a top film 11 which has an opaque portion 10.

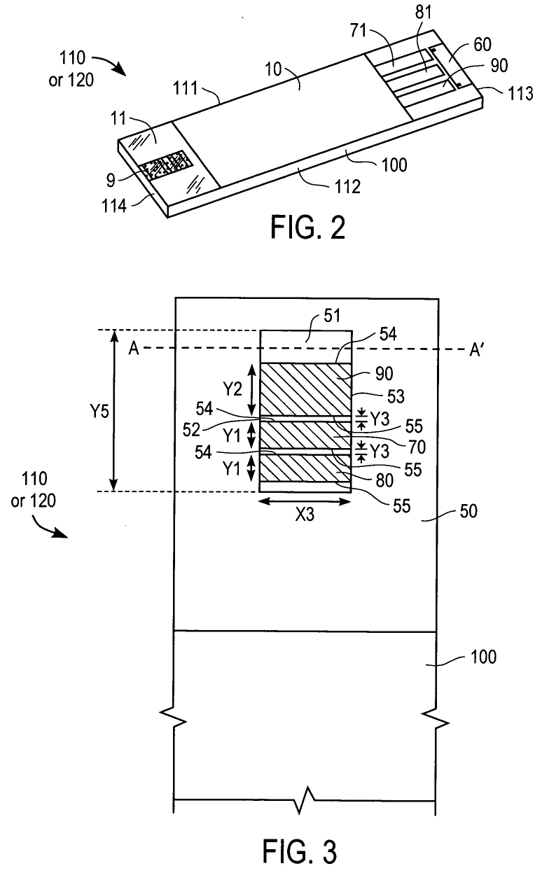

FIG. 2 is a perspective view of an assembled test strip of either the prior art invention or the present invention. In either embodiment, a sample inlet 9 is created in test strip (110 or 120) when it is cut along a line A-A′ as illustrated in FIG. 3. Test strip (110 or 120) further includes a first side edge 111, a second side edge 112, a proximal side edge 113 and a distal side edge 114. In addition, distal side edge of strip 110 is adjacent to sample inlet 9 and the proximal side edge is adjacent to strip detection bar 60.

FIG. 3 is a simplified plane view of a distal portion of a test strip (110 or 120) according to either the prior art invention or the present invention which includes a conductive layer and an insulation layer wherein incision line A-A′ is illustrated. FIG. 3 further includes insulation layer 50, cutout 51, first working electrode 70, second working electrode 80, and reference electrode 90, an electrode width X3, a working electrode length Y1, a reference electrode length Y2, and an electrode spacing Y3. Prior art test strips having an electrode arrangement similar to that of the present invention are described in international publications WO 01/67099A1 and WO 01/73124A2 which are incorporated in full by reference herein. FIG. 3 further illustrates the various structural differences which will be described in more detail hereinafter especially in reference to the position of reagent layer 40, second adhesive pad 31, and third adhesive pad 32.

A test strip according to the present invention is manufactured in a series of steps wherein the elements illustrated in FIGS. 1A and 1B are deposited on a substrate using, for example, a screen printing process. Note that in the present invention the position of second adhesive pad 31 and third adhesive pad 32 overlaps with reagent layer 40 in contrast to FIG. 1A where second adhesive pad 31 and third adhesive pad 32 do not touch reagent layer 40. In one embodiment of the present invention, substrate 100 is an electrically insulating material such as plastic, glass, ceramic, and the like. In a preferred embodiment of this invention, substrate 100 may be a plastic such as, for example, nylon, polycarbonate, polyimide, polyvinylchloride, polyethylene, polypropylene, PETG, or polyester. More particularly the polyester may be, for example Melinex® ST328 which is manufactured by DuPont Teijin Films. Substrate 100 may also include an acrylic coating which is applied to one or both sides to improve ink adhesion.

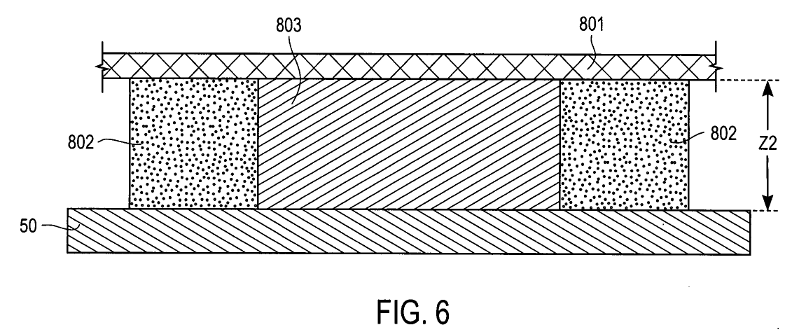

The first layer deposited on substrate 100 is a conductive layer which includes first working electrode 70, second working electrode 80, reference electrode 90, and strip detection bar 60. The conductive layer may be disposed on substrate 100 in a particular geometry as shown in FIGS. 1A and 1B. In accordance with the present invention, a screen mesh 801 with an emulsion pattern 802 as illustrated in FIG. 6 may be used to deposit printed material 803 such as, for example, a conductive carbon ink in a defined geometry such as those shown in FIGS. 1A and 1B. Emulsion pattern 802 may act as a mask allowing printed material to selectively pass through screen mesh 801. It should be appreciated that one skilled in the art could make alternative embodiments for the geometry of the conductive layer for this invention. It should also be noted that a reference electrode 90 may also be a counter electrode, a reference/counter electrode, or a quasi-reference electrode. The conductive layer my be printed on to substrate 100 by using screen printing, sputtering, evaporation, electroless plating, ink jetting, sublimation, chemical vapor deposition, and the like. Suitable materials which may be used for the conductive layer are Au, Pd, Ir, Pt, Rh, stainless steel, doped tin oxide, carbon, and the like. In an embodiment of this invention, the carbon ink layer may have a height between 1 and 100 microns, more favorably between 5 and 25 microns, and yet even more favorably at approximately 13 microns. However, it should be noted that the height of the conductive layer can vary depending of the desired resistance of the conductive layer and the conductivity of the material used for printing the conductive layer.

The second layer deposited on substrate 100 is insulation layer 50 such that insulation layer 50 is disposed on at least a portion of the conductive layer as shown in FIGS. 1-3. In accordance with the present invention, a screen mesh 801 with an emulsion pattern 802 as illustrated in FIG. 6 may be used to deposit printed material 803 such as, for example, an insulation ink in a defined geometry such as those shown in FIG. 3. Emulsion pattern 802 may act as a mask allowing printed material to selectively pass through screen mesh 801. Insulation layer 50 further includes a cutout 51 which exposes a portion of the conductive layer to define an electrochemical surface area. The electrochemical surface area includes the portion of first working electrode 70, second working electrode 80, and reference electrode 90 which can be wetted by a liquid sample. Cutout 51 may be in the form of a rectangular cutout which has a first side 52 and second side 53, wherein the first and second side (52 and 53) of cutout 51 defines electrode width X3 for first working electrode 70, second working electrode 80, and reference electrode 90. Cutout 51 may further include a cutout length Y5 as illustrated in FIG. 3. In an embodiment of this invention, electrode width X3 may be between 10 microns to 5 mm, more favorably between 0.1 to 1 mm, and yet even more favorably at approximately 0.72 mm. A distal electrode side 54 and a proximal electrode side 55 of first working electrode 70, second working electrode 80, and reference electrode 90 further defines the respective working and reference electrode length (Y1 and Y2) as illustrated in FIG. 3. The distance between the distal and proximal electrode side (54 and 55) of first working electrode 70 and second working electrode 80 may be a working electrode length Y1 which is illustrated in FIG. 3. In an embodiment of this invention, working electrode length Y1 may be between 10 microns to 5 mm, more favorably between 0.1 to 1 mm, and yet even more favorably at approximately 0.8 mm. As illustrated in FIG. 3, the distance between the distal and proximal electrode side (54 and 55) of reference electrode 90 may be a reference electrode length Y2 which may be approximately 50% of working electrode length Y1 or greater. In an embodiment in accordance with the present invention, reference electrode length Y2 is about twice as big as working electrode length Y1. In this embodiment reference electrode 90 has an electrochemical surface area about twice as big as either first or second working electrode (70 or 80). An electrode spacing Y3 as illustrated in FIG. 3 defines the closest gap between reference electrode and first working electrode; and also between first working electrode and second working electrode. It should be noted that the optimal electrode spacing Y3 depends on a host of factors such as duration of the electrochemical assay, diffusion coefficient of the electroactive species, desirability of semi-infinite diffusion controlled conditions versus a significant diffusion of redox couple between electrodes, and the like which are also described in U.S. Pat. No. 6,284,125 and published international application WO01/73124A2 which are incorporated in full by reference herein. In an embodiment of this invention using a 5 second test time, a blood sample type, and semi-infinite diffusion, electrode spacing Y3 may be between 10 microns to 5 mm, more favorably between 20 microns to 0.3 mm, and yet even more favorably at approximately 0.2 mm. It should be noted that one skilled in the art could envisage other embodiments of the present invention where the, insulation layer may have more than one cutout to expose portions of the conductive layer and also incorporate geometrical shapes other than rectangles such as, for example, circles, squares, diamonds, hexagons, and the like.

In an embodiment of this invention insulating layer 50 may be printed by using one of the aforementioned techniques used for the conductive layer. In a preferred embodiment of this invention, insulating layer 50 may be printed by using screen printing techniques in either a flat bed process or in a continuous web process. A suitable materials which may be used for insulating layer 50 is Ercon E6110-116 Jet Black Insulayer Ink which may be purchased from Ercon, Inc. It should be appreciated that one skilled in the art that several different types of insulating material could be suitable for use in the described invention. In an embodiment of this invention, insulating layer 50 may have a height between 1 microns and 100 microns, more favorably between 5 and 25 microns, and yet even more favorably at about 5 microns.

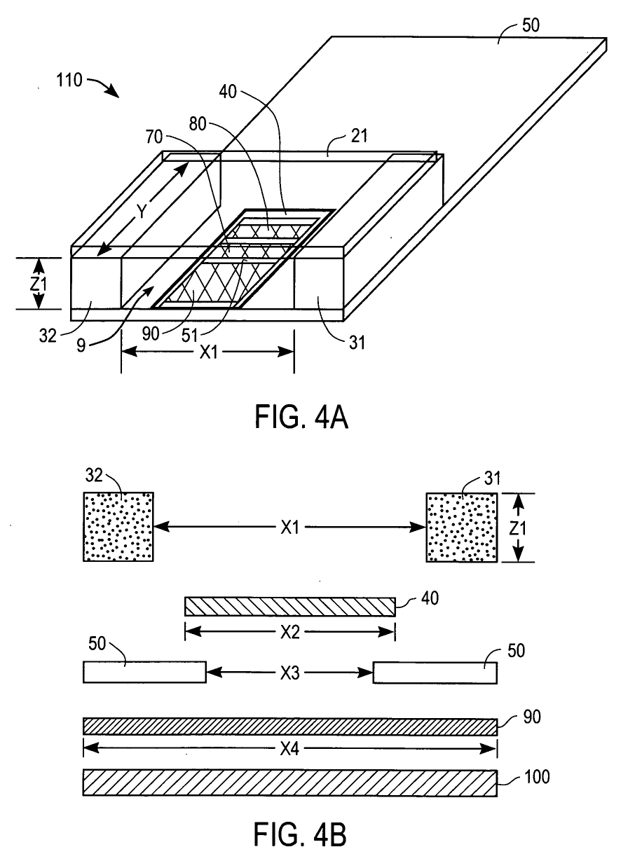

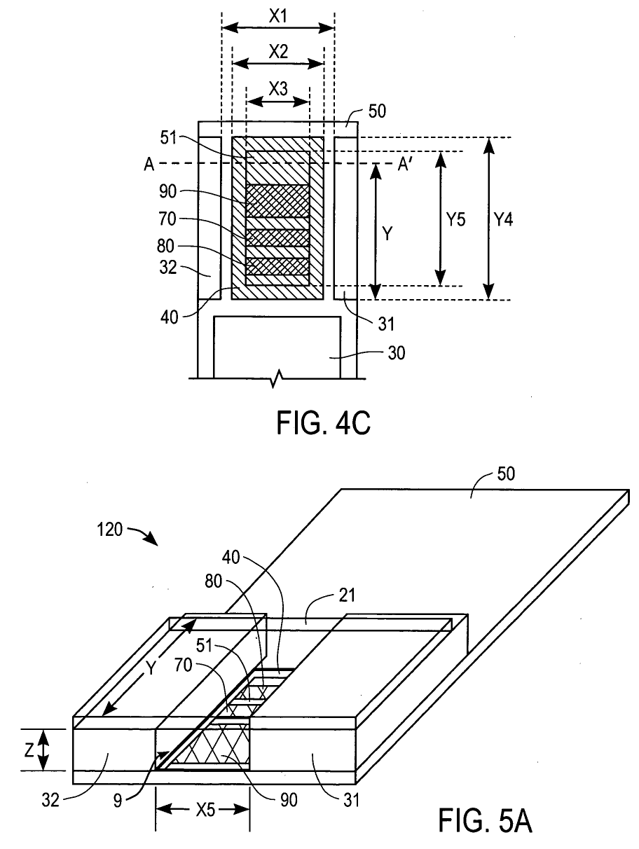

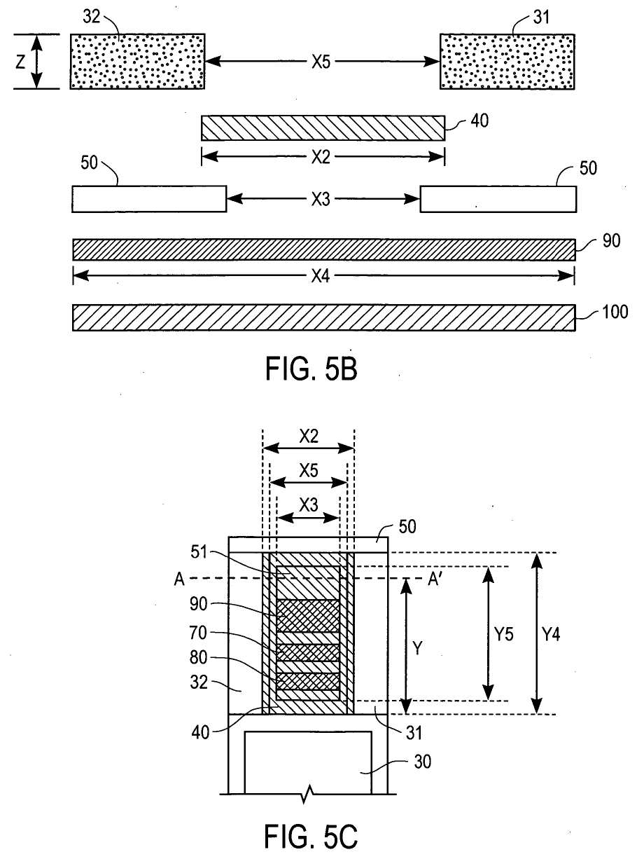

The third layer deposited on substrate 100 is reagent layer 40 such that reagent layer 40 is disposed on at least a portion of the conductive layer as shown in FIGS. 4C and 5C. In accordance with the present invention, a screen mesh 801 with an emulsion pattern 802 as illustrated in FIG. 6 may be used to deposit printed material 803 such as, for example, a reagent in a defined geometry such as those shown in FIGS. 4C and 5C. Emulsion pattern 802 may act as a mask allowing printed material to selectively pass through screen mesh 801. Reagent layer 40 may be printed in a rectangular shape having a reagent width X2 and a reagent length Y4 as shown in FIGS. 4C and 5C. In a preferred embodiment of this invention, reagent width X2 and reagent length Y4 may be the same as or at least slightly more than the respective electrode width X3 and cutout length Y5 to ensure complete coverage of cutout 51 with reagent layer 40.

It should be appreciated that one skilled in the art could either coat the reagent layer on only one of the aforementioned electrodes, or on any permutation using only 2 of the 3 electrodes (i.e. first working electrode 70 and reference electrode 90). Furthermore, one skilled in the art could also coat the bottom side of second hydrophilic film 21 with reagent alone or in combination thereof with a coating of at least one other electrode having an electrochemical surface area, wherein the bottom side is facing and adjacent to the conductive layer.

An example of a suitable reagent may be an enzyme ink for use in the present invention which is summarized in Table 1.

TABLE 1

| Component | Supplier |
|---|---|
| Glucose Oxidase | Biozyme Laboratories |
| Tn-sodium Citrate | Fisher Scientific |
| Citric Acid | Fisher Scientific |
| Poly Vinyl Alcohol | Sigma Aldrich |
| Hydroxyethylcellulose (Nat 250 G) | Honeywell and Stein |
| | BDH/Merck LTD |
| | Sigma-Aldrich Chemical Co., |
| | UK |
| Potassium hexacyanoferrate III | Norlab Instruments Ltd., UK |
| DC 1500 Antifoam | BDH/Merck Ltd |
| Cabosil | Ellis and Everard Ltd |
| PVPVA | ISP Company Ltd |
| Analar Water | BDH/Merck Ltd |

It should be appreciated that one skilled in the art that variations of the previously described enzyme ink could be suitable for use in the described invention. In an embodiment of this invention, reagent layer 40 may have a height between about 1 to 100 microns and more favorably between about 5 to 25 microns.

The fourth layer deposited on substrate 100 is an adhesive layer such that the adhesive layer 50 is disposed on at least a portion of insulation layer 50. In accordance with the present invention and prior art invention, the adhesive layer includes first, second, and third adhesive pads (30, 31, and 32) as shown in FIGS. 1A and 1B. In accordance with the present invention, a screen mesh 801 with an emulsion pattern 802 as illustrated in FIG. 6 may be used to deposit printed material 803 such as, for example, an adhesive in a defined geometry such as those shown in FIGS. 1A and 1B. Emulsion pattern 802 may act as a mask allowing printed material to selectively pass through screen mesh 801.

FIG. 4A-4C will show a respective perspective, cross-sectional view, and plane view of test strip 110 according to the prior art invention to clarify the non-overlapping position of the adhesive layer to reagent layer 40.

FIG. 4A is a simplified perspective view of a distal portion of test strip 110 according to the prior art invention. The distal portion of test strip 110 includes a second hydrophilic film 21, reagent layer 40, insulation layer 50, a cutout 51, a sample inlet 9, a second adhesive pad 31, a third adhesive pad 32, a first working electrode 70, a second working electrode 80, a reference electrode 90, a sample receiving chamber width X1, a sample receiving chamber length Y, and an adhesive height Z1.

FIG. 4B is a cross-sectional view of the test strip 110 illustrated in FIG. 4A. The cross-sectional view cuts in a line that goes through reference electrode 90 from the first side edge to the second side edge of test strip 110. The cross-sectional view of test strip 110 includes second and third adhesive pads (31 and 32), reagent layer 40, insulation layer 50, reference electrode 90, substrate 100, adhesive height Z1, sample receiving chamber width X1, reagent layer width X2, electrode width X3, and substrate width X4.

FIG. 4C is a simplified plane view of a distal portion of test strip 110 illustrated in FIG. 4A including a conductive layer, an insulation layer 50, a reagent layer 40, and an adhesive layer. Test strip 110 further includes cutout 51, first adhesive pad 30, second adhesive pad 31, third adhesive pad 32, first working electrode 70, second working electrode 80, reference electrode 90, incision line A-A′, sample receiving chamber length Y, reagent length Y4, cutout length Y5, sample receiving chamber width X1, reagent width X2, and electrode width X3.

In an embodiment of the prior art invention, second and third adhesive pads (31 and 32) do not touch or overlap with reagent layer 40. It was previously believed that the adhesive layer should not touch or overlap with reagent layer 40 because chemicals in the adhesive layer may migrate into reagent layer 40 and react with the enzyme and/or redox mediator causing stability problems. In addition, it was also believed that the adhesive layer should not touch reagent layer 40 so that the adhesive layer can form a strong liquid impermeable seal with insulation layer 50. This would allow the sample receiving chamber volume to remain constant with time. In an embodiment of the prior art invention, first, second and third adhesive pads (30, 31, and 32) have an adhesive height Z1 which may be about 120 microns. It is desirable that adhesive height Z1 be larger than the height of reagent layer 40 to avoid second hydrophilic film 21 from contacting and damaging reagent layer 40 (see FIG. 4A).

FIG. 5A-5C will show a respective perspective, cross-sectional view, and plane view of test strip 120 according to the present invention to clarify the overlap of the adhesive layer to reagent layer 40.

FIG. 5A is a simplified perspective view of a distal portion of a reduced volume test strip 120 according to the present invention. The distal portion of test strip 120 includes a second hydrophilic film 21, reagent layer 40, insulation layer 50, a cutout 51, a sample inlet 9, a second adhesive pad 31, a third adhesive pad 32, a first working electrode 70, a second working electrode 80, a reference electrode 90, a reduced chamber width X5, a sample receiving chamber length Y, and a reduced adhesive height Z.

FIG. 5B is a cross-sectional view of the test strip 120 illustrated in FIG. 5A. The cross-sectional view cuts in a line that goes through reference electrode 90 from the first side edge to the second side edge of test strip 120. The cross-sectional view of test strip 120 includes second and third adhesive pads (31 and 32), reagent layer 40, insulation layer 50, reference electrode 90, substrate 100, reduced adhesive height Z, reduced chamber width X5, reagent layer width X2, electrode width X3, and substrate width X4.

FIG. 5C is a simplified plane view of a distal portion of test strip 120 illustrated in FIG. 5A including a conductive layer, an insulation layer 50, a reagent layer 40, and an adhesive layer. Test strip 120 further includes cutout 51, first adhesive pad 30, second adhesive pad 31, third adhesive pad 32, first working electrode 70, second working electrode 80, reference electrode 90, incision line A-A′, sample receiving chamber length Y, reagent length Y4, cutout length Y5, reduced chamber width X5, reagent width X2, and electrode width X3.

In an embodiment of the present invention, second and third adhesive pads 31 and 32 approach reagent layer 40 so that at least one part of either second or third adhesive pads (31 or 32) touches reagent layer 40. Typically, both second and third pads touch and indeed overlap reagent layer 40 so that reduced chamber width X5 is approximately equal or less than reagent width X2. Although typically both second or third pads (31 or 32) touch and even overlap reagent layer 40, this invention may also include those embodiments where only one pad touches reagent layer 40 and reduced chamber width X5 is slightly greater than reagent width X2. This situation may arise because of manufacturing tolerances in printing the adhesive layer.

In an embodiment of the present invention, reagent width X2 is always greater than or equal to reduced chamber width X5, and reagent width X2 is greater than electrode width X3. This results in a test strip in which the electrode surface area is at least partially defined by the insulation layer and not by the adhesive layer. The definition of the working electrode area is of particular importance because the magnitude of current output of the test strip is directly proportional to the working electrode area. A modest change of about 5% or less in the definition of the working electrode area may significantly degrade the accuracy of the glucose output.

In an embodiment of the present invention, test strip 120 may have a portion of enzyme layer 40 in physical contact with the adhesive layer. Previously, it was believed that reagent layer 40 should not be in physical contact with the adhesive layer because chemicals in the adhesive can migrate into enzyme layer 40 and react with the enzyme and/or redox mediator causing stability problems. In particular, it was unexpected that the use of water based adhesives could be used in the test strip because moisture within the adhesive layer may lead to the instability of the redox mediator and redox enzyme. In addition, it was not anticipated that having the adhesive layer overlapping reagent layer 40 could form a liquid impermeable barrier to form the walls of the sample receiving chamber allowing a relatively constant sample receiving chamber volume to be maintained during the measurement. Initially, it was believed that reagent layer 40 would solubilize underneath the adhesive layer causing the volume of the sample receiving chamber to change with time. Such a change in chamber volume, if sufficiently large enough may also degrade the accuracy of the glucose concentration output. The sample receiving chamber should be designed to have a relatively constant volume over the duration of the test such that if does not affect the glucose output. It is now believed that the use of a water based adhesive helps improve the liquid impermeable barrier within the sample receiving chamber and does not cause any instability to the reagent layer. Because the adhesive contains a significant amount of water such as, for example, 50% by weight, the adhesive initially causes reagent layer 40 to partially dissolve allowing the acrylic copolymer to stick strongly to either substrate 100 and/or insulation layer 50 such that it is sufficient to bind the layers together and define a sufficiently stable sample receiving chamber volume for at least 5 seconds.

In an embodiment of the present invention, first, second, and third adhesive pads (30, 31, and 32) have a reduced adhesive height Z as shown in FIGS. 5A and 5B. The minimal value for reduced adhesive height Z is bounded by the height of reagent layer 40 because it would be undesirable for second hydrophilic film 21 to physically contact reagent layer 40 and result in possible damage to reagent layer 40. The maximum value of adhesive height Z is bounded by the desire to reduce the overall sample volume of the test strip and also to maintain conditions for semi-infinite diffusion in regards to the mediator oxidation (i.e. concentration of redox mediator which is sufficiently far from the electrodes are unperturbed by electrochemical reactions). In an embodiment of this invention using a 5 second test for measuring glucose in blood under a semi-infinite diffusion regime, a reduced adhesive height Z may have a height between 10 and 500 microns, more favorably between 20 and 200 microns, and yet even more favorably between approximately 70 and 110 microns. It should be obvious to one skilled in the art, a smaller reduced adhesive height Z may be used when modifying the test to a shorter test time. In a preferred embodiment of this invention, adhesive is printed using a screen mesh 801 as illustrated in FIG. 6. In order to define the printed pattern, screen mesh 801 has an emulsion pattern 802 which selectively allows printed material 803 to be printed onto insulating layer 50. In such a case, printed material 803 may be an adhesive material. An emulsion height Z2 contributes to the eventual adhesive height Z. In general, emulsion height Z2 is always slightly larger than the final adhesive height Z because the adhesive ink relaxes to a smaller dimension. In accordance with the present invention, an adhesive printed with screen mesh 801 having an emulsion height of about 120 microns with print an adhesive layer having a final relaxed height of about 70 to 110 microns.

Examples of methods to print first, second, and third adhesive pad (30, 31, and 32) may be screen printing, gravure, and slot coating. In other embodiments, the adhesive pads may be pre-formed by die cutting, laser scribing, or punching an adhesive material before lamination onto insulation layer 50. In yet another embodiment, the adhesive pads may comprise a double sided pressure sensitive adhesive, a UV cured adhesive, heat activated adhesive, or a thermosetting plastic. As a non-limiting example, the adhesive pads may be formed by screen printing a pressure sensitive adhesive such as, for example, a water based acrylic copolymer pressure sensitive adhesive which is commercially available from Tape Specialties LTD in Tring, Herts, United Kingdom (part #A6435). It should be noted that screen printed adhesive has an advantage in that no intermediate support layer is required in the adhesive layer, unlike double sided adhesive which usually has an intermediate support. Additionally, screen printed adhesive has more flexibility in creating designs in the adhesive layer by using a patterned emulsion on the screen compared to the use of double sided tape which usually requires additional converting steps such as punching, removing release liners, and adhesive slugs.

The fifth layer deposited on substrate 100 is an hydrophilic layer such that the hydrophilic layer is disposed on at least a portion of the adhesive layer. The hydrophilic layer includes first and second hydrophilic layers (20 and 21). The lamination of the hydrophilic layer forms the “roof” of the sample receiving chamber. The “side walls” and “floor” of the sample receiving chamber are formed by a portion of the adhesive layer and substrate 100, respectively. As a non-limiting example, the hydrophilic material may be an optically transparent polyester coating with a hydrophilic anti-fog coating such as those commercially obtained from 3M. The hydrophilic nature of the coating is used in the design of the strip because it facilitates filling of liquid into the sample receiving chamber. As illustrated in FIGS. 1A and 1B, second hydrophilic film 21 comprises a rectangle which may be disposed over second and third adhesive pads (31 and 32) and first hydrophilic film 20 also comprises a rectangle which may be disposed over first adhesive pad 30.

In an embodiment either the prior art or the present invention, second hydrophilic film has a width which corresponds to the distance between approximately the first and second side edge of test strip 120 and a length which corresponds to approximately to sample receiving chamber length Y as illustrated in FIGS. 4A and 5A. As a non-limiting example, sample receiving chamber length Y may be about 1.93 mm. The gap between first and second hydrophilic film forms a passageway which is sufficiently large to allow air to be vented from the sample receiving chamber and allow rapid filling of the sample receiving chamber. In addition, the gap is also sufficiently large, so that it forms a stop junction causing the liquid sample to stop filling the sample receiving chamber at the proximal end of second hydrophilic film 21.

The sixth layer deposited on substrate 100 is a top film 11 such that top film 11 is disposed on first or second hydrophilic film. In accordance with the present invention, top film 11 includes a clear polyester which is coated on one side with a pressure sensitive. Top film 11 has an opaque portion which helps the user observe a high degree of contrast between the clear sample receiving chamber and the opaque section of the top film. This allows a user to visually confirm that the sample receiving chamber is sufficiently filled.

In accordance with the present invention, test strip 120 may also be referred to as a sensor for performing an electrochemical test for an analyte. Examples of analytes may be glucose, lactate, hemoglobin, and hydrogen peroxide. Instead of measuring an analyte it is also possible to measure a characteristic of blood, such as, for example hematocrit or coagulation.

### EXAMPLE 1

Two batches of test strips were prepared where batch 1 does not have adhesive layer touching the reagent layer and batch 2 does have an adhesive layer touching the reagent layer. In particular, batch 1 and 2 test strips were constructed using the designs according to FIG. 4A-C and FIG. 5A-C, respectively. Strip contacts 71, 81, and 91 were connected to a meter which has the means to apply a constant potential of 0.4 V between strip contact 71 and 91, and also between strip contact 81 and 91. A sample of blood is applied to sample inlet 9 allowing the blood to wick into the sample receiving chamber and to wet first working electrode 70, second working electrode 80, and reference electrode 90. Reagent layer 40 becomes hydrated with blood and then generates ferrocyanide which is proportional to the amount of glucose present in the sample. After about 5 seconds from the sample application to the test strip, an oxidation of ferrocyanide is measured as a current for both first and second working electrode (70 and 80) which is proportional to the amount of glucose. Based on a previously performed calibration, the meter is able to convert the measured current magnitude into a glucose concentration value which accurately represents the concentration of glucose in the blood sample. A test was performed showing that batch 2 has the same precision as batch 1 which shows that having reagent touch the adhesive layer does not degrade the precision performance of the test. Table 1 shows the results of this test in which 8 replicates were performed at 5 glucose levels and with 12 blood donors for each batch of strips.

TABLE 1
Summary of precision data for strip not having adhesive
overlapping with reagent (batch 1) and having overlapping
with reagent (batch 2).

| | | Mean Glucose | Standard | | |
|---|---|---|---|---|---|
| | Glucose | Response - | Deviation, | | |
| Batch | Level | mg/dL | n = 96 | CV | Average CV |
| 1 | 1 | 39.46 | 0.88 | 2.22 | 2.33 |
| 1 | 2 | 70.33 | 0.65 | 0.93 | |
| 1 | 3 | 134.69 | 5.50 | 4.08 | |
| 1 | 4 | 251.92 | 3.87 | 1.54 | |
| 1 | 5 | 375.58 | 10.77 | 2.87 | |
| 2 | 1 | 39.67 | 0.98 | 2.48 | 2.53 |
| 2 | 2 | 75.85 | 2.08 | 2.74 | |
| 2 | 3 | 135.17 | 4.37 | 3.23 | |
| 2 | 4 | 245.08 | 5.74 | 2.34 | |
| 2 | 5 | 383.54 | 7.10 | 1.85 | |

Table 1 shows that the average CV for both batches were the about the same for batch 1 and 2 having an average CV of 2.33 and 2.53, respectively. This body of data shows that having adhesive overlapping the reagent layer does not degrade the overall strip-to-strip precision of the glucose measurement over a broad range of glucose concentrations. Additionally, the adhesive layer is capable of forming a sufficiently good seal of the sample receiving chamber such that the volume of blood does not sufficiently increase over a 5 second period such that it affects the accuracy of the glucose measurement.

### EXAMPLE 2

An experiment was performed to show that ferricyanide was stable when the adhesive layer overlaps reagent layer 40. Batch 1 and 2 strips, as described in Example 1 , were aged for 11 days at 22, 40, and 50° C. It should be noted that heat stressing the strips accelerates its aging to simulate long term storage at room temperature. Ferricyanide has a tendency to auto-reduce during storage in the dry state into ferrocyanide which causes an overall increase in an oxidation background current and also decreases the accuracy of the glucose measurement. It is known that residual water moisture can accelerate the auto-reduction of ferricyanide. In certain situations, adhesive contact with the reagent layer can accelerate this decomposition. Table 2 shows the increase in background current is the same for both batch 1 and 2 at all temperatures. The strips were tested by dosing the sample receiving chamber with a phosphate buffer saline solution containing no glucose and tested in a manner similar to Example 1. The measured current of this test is proportional to the amount of ferrocyanide in the test strip. This body of data supports that the use of water based adhesive and its contact with the reagent layer does not degrade the stability of the ferricyanide complex.

TABLE 2
Summary of current output for aged strips when tested with
phosphate buffer saline

| | | Bias to Day 0 | Bias to Day 0 | |
|---|---|---|---|---|
| Temperature - | Time - | in microamps - | in microamps - | Batch 2 − |
| ° C. | Days | Batch 1 | Batch 1 | Batch 1 |
| 22 | 0 | 0.00 | 0.00 | 0.00 |
| | 3 | 0.01 | −0.03 | −0.04 |
| | 7 | 0.00 | −0.05 | −0.05 |
| | 11 | 0.01 | −0.02 | −0.03 |
| 40 | 0 | 0.00 | 0.00 | 0.00 |
| | 3 | 0.05 | 0.00 | −0.05 |
| | 7 | 0.00 | −0.01 | −0.01 |
| | 11 | 0.03 | 0.01 | −0.03 |
| 50 | 0 | 0.00 | 0.00 | 0.00 |
| | 3 | 0.09 | 0.02 | −0.07 |
| | 7 | 0.06 | 0.05 | −0.01 |
| | 11 | 0.10 | 0.07 | −0.03 |

### EXAMPLE 3

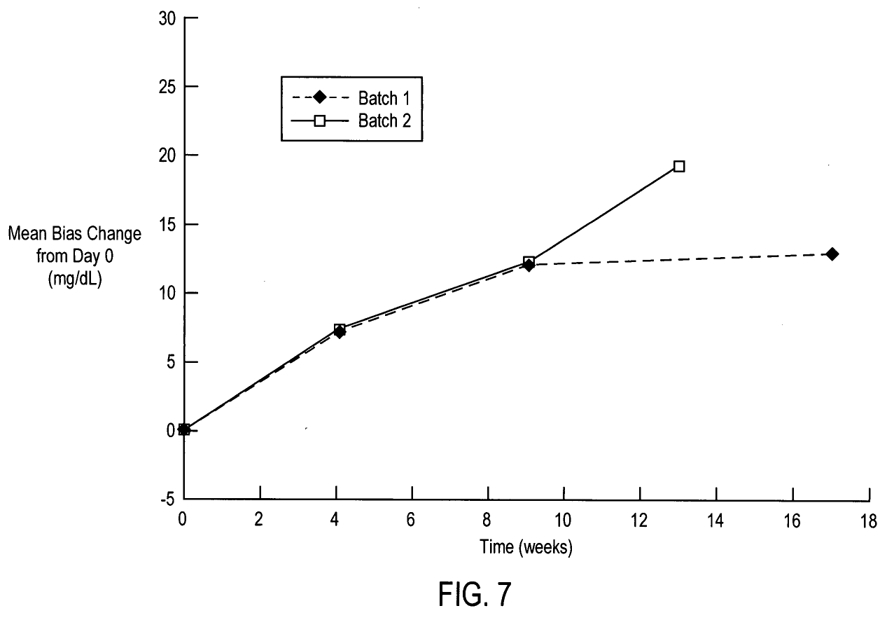

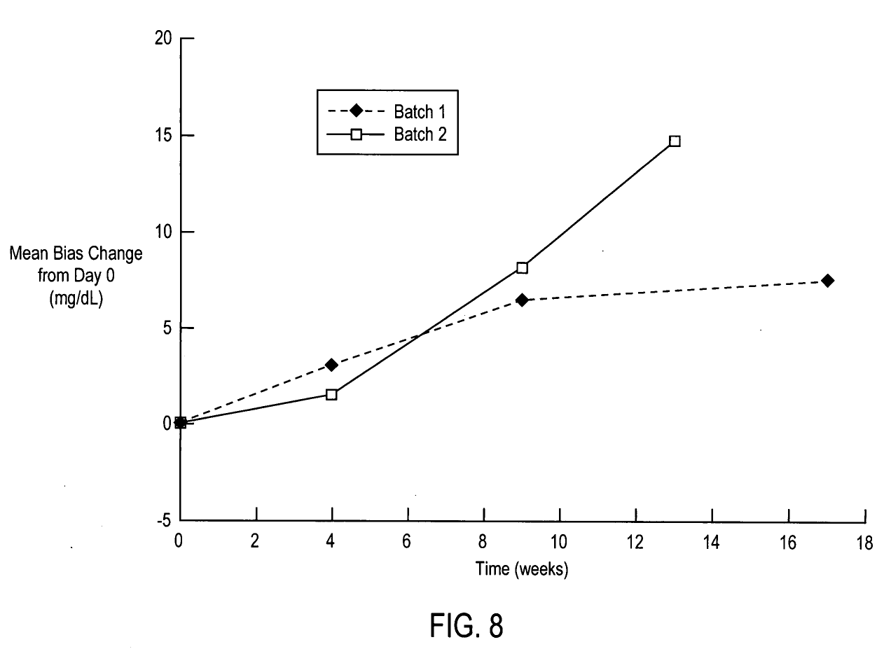

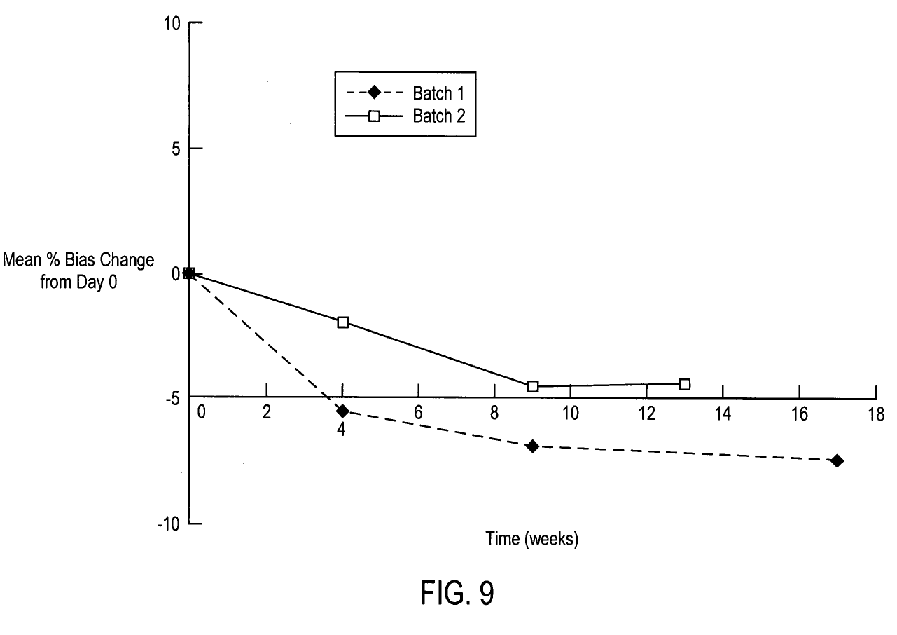

An experiment was performed to show that the glucose response was stable when the adhesive overlaps reagent layer 40. Batch 1 and 2 strips, as described in Example 1, were aged for 12 weeks at 50° C. It should be noted that heat stressing the strips accelerates its aging to simulate long term storage at room temperature. The aged strips were tested with blood at 50, 100, and 500 mg/dL glucose concentration. FIGS. 7-9 show that the overall bias to day 0 did not change significantly when comparing batch 1 to batch 2. This body of data supports that the use of water based adhesive and its contact with the reagent layer does not degrade the stability of the-enzyme.

It will be recognized that equivalent structures may be substituted for the structures illustrated and described herein and that the described embodiment of the invention is not the only structure which may be employed to implement the claimed invention. In addition, it should be understood that every structure described above has a function and such structure can be referred to as a means for performing that function.

While preferred embodiments of the present invention have been shown and described herein, it will be obvious to those skilled in the art that such embodiments are provided by way of example only. Numerous variations, changes, and substitutions will now occur to those skilled in the art without departing from the invention.

It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A sensor for performing an electrochemical test for an analyte in a sample comprising:
a substrate;
a conductive layer disposed on said substrate, and wherein said conductive layer comprises a reference electrode and at least one working electrode;
an insulation layer disposed on at least a part of said conductive layer so as to expose a portion of said conductive layer;
a reagent layer covering at least a part of said exposed portion of said conductive layer; and
an adhesive layer defining at least part of a wall of a sample receiving chamber and further wherein said adhesive layer covers at least a portion of said reagent layer.

2. The electrochemical sensor of claim 1 in which said adhesive layer further comprises a water based pressure sensitive adhesive.

3. The electrochemical sensor of claim 1 in which said adhesive layer overlaps at least a part of said reagent layer.

4. The electrochemical sensor according to claim 1, in which said adhesive layer defines more than one wall of a sample chamber and at least two walls touch said reagent layer.

5. The electrochemical sensor of claim 3 in which at least two of said walls overlap with said reagent layer

6. A sensor for performing an electrochemical test for an analyte in a sample comprising:
a substrate;
a conductive layer disposed on said substrate, and wherein said conductive layer comprises a reference electrode and at least one working electrode;
an insulation layer disposed on at least a part of said conductive layer so as to expose a portion of said conductive layer;
a reagent layer covering at least a part of said exposed portion of said conductive layer; and
an adhesive layer defining at least part of a wall of a sample receiving chamber, said wall having a lower edge lying inwards, with respect to a center of said sample receiving chamber, of at least a portion of an outer edge of said reagent layer so that a portion of said adhesive layer lies on top of a portion of said reagent layer.

7. The electrochemical sensor as in claim 1, wherein a width of a sample receiving chamber is between about 10 microns and 1.5 mm.

8. The electrochemical sensor as in claim 6, which further comprises a width of a sample receiving chamber is between about 0.4 and 0.9 mm.

9. The electrochemical sensor as in claim 1, wherein said reagent layer comprises a material selected from the group consisting of a redox mediator, a redox enzyme, and a thromboplastin.

10. The electrochemical sensor as in claim 1, further comprises a top layer which is disposed on said adhesive layer to form a ceiling for said sample receiving chamber.

11. The electrochemical sensor as in claim 1, wherein said adhesive layer has a height between about 10 and 150 microns.

12. The electrochemical sensor as in claim 10, wherein said adhesive laser has a height between about 70 and 110 microns.

13. The electrochemical sensor as in claim 10, wherein said adhesive laser has a height between about 70 and 90 microns.

14. The electrochemical sensor as in claim 9, wherein said adhesive laser has a height between about 10 and 150 microns.

15. The electrochemical sensor as in claim 14, wherein said adhesive laser has a height between about 70 and 110 microns.

16. The electrochemical sensor as in claim 15, wherein said adhesive laser has a height between about 70 and 90 microns.

17. The electrochemical sensor as in claim 1, in which said reagent layer covers all of said exposed portion of said conductive layer.

18. The electrochemical sensor as in claim 1, wherein said conductive layer comprises a material selected from the group consisting of Au, Pd, Ir, Pt, Rh, stainless steel, doped tin oxide, and carbon.

19. The electrochemical sensor as in claim 1, wherein said substrate comprises a material selected from the group consisting of nylon, polyester, polycarbonate, polyimide, polyvinylchloride, polyethylene, polypropylene, and PETG.

20. The electrochemical sensor as in claim 1, wherein said adhesive is a pressure sensitive adhesive.

21. The electrochemical sensor as in claim 1, wherein said test determines a concentration of said analyte.

22. The electrochemical sensor as in claim 21, wherein said analyte is glucose.

23. The electrochemical sensor as in claim 1, wherein said test determines a coagulation time of a physiological fluid.

24. The electrochemical sensor as in claim 1, wherein said test strip is a disposable test strip.

25. An electrochemical sensor kit comprising:
said sensor as in claim 1
a meter which has a means for electrically interfacing with said test strip and a means for measuring glucose.

26. A method for making a sensor for performing an electrochemical test for an analyte in a sample comprising:
applying a conductive layer to a substrate, wherein said conductive layer comprises a reference electrode and at least one working electrode;
applying an insulation layer to at least a part of said conductive layer so as to expose a portion of said conductive layer;
applying a reagent layer which covers at least a part of said exposed portion of said conductive layer;
applying an adhesive layer which touches at least a portion of said reagent layer and defines at least part of a wall of a sample receiving chamber; and
applying a top layer to said adhesive layer to form a ceiling for said sample receiving chamber.
